(19) United States
(12) Patent Application Publication
(10) Pub. No.: US 2009/0323325 A1
(43) Pub. Date: Dec. 31, 2009

(54) LED LAMP

(75) Inventors: BIN LONG, Shenzhen City (CN); GUANG YU, Shenzhen City (CN); JIAN-HUA YAN, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: FU ZHUN PRECISION INDUSTRY (SHEN ZHEN) CO., LTD., Shenzhen City (CN); FOXCONN TECHNOLOGY CO., LTD., Tu-Cheng (TW)

(21) Appl. No.: 12/261,049

(22) Filed: Oct. 30, 2008

(30) Foreign Application Priority Data
Jun. 27, 2008 (CN) 200810068064.X

(51) Int. Cl. F21V 29/00

(52) U.S. Cl. 362/234

(57) ABSTRACT

An LED lamp includes a lamp seat, a prism-shaped first heat sink disposed on a top of the lamp seat, a second heat sink covering a top of the first heat sink, a plurality of heat pipes thermally connecting the first heat sink with the second heat sink, a plurality of LED modules mounted on the first heat sink and an envelope located between the lamp seat and the second heat sink and surrounding the first heat sink. The first heat sink includes an annular base and a plurality of first fins and second fins extending therefrom. The LED modules are mounted on the first fins, respectively. Each heat pipe has two parallel sections respectively attached to a corresponding first fin and an inner circumferential periphery of the annular base.

### BACKGROUND OF THE INVENTION

1. Field of the Invention

The disclosure relates to a light emitting diode (LED) lamp, and more particularly to an LED lamp having enhanced heat dissipating capability.

2. Description of Related Art

An LED lamp as a new type of light source can generate brighter light, and have many advantages, e.g., energy saving, environment friendly and longer life-span, compared to conventional light sources. Therefore, the LED lamp has a trend of substituting for conventional lamps.

Conventionally, an LED lamp comprises a cylindrical enclosure functioning as a heat sink and a plurality of LEDs mounted on an outer wall of the enclosure. The LEDs are arranged in a plurality of lines along a height of the enclosure and around the enclosure. The enclosure defines a central through hole along the height thereof. When the LEDs are activated, heat generated by the LEDs is dispersed to ambient space via the enclosure by air convection.

However, in order to achieve compact design and convenient transportation and handling, the LED lamp is small, as is the enclosure, correspondingly, which limits heat dissipating area thereof, possibly leading to the LEDs overheating and even failing.

What is needed, therefore, is an LED lamp which can overcome the limitations described.

### SUMMARY OF THE INVENTION

An LED lamp comprises a lamp seat, a prism-shaped first heat sink disposed on a top of the lamp seat, a second heat sink covering a top of the first heat sink, a plurality of heat pipes thermally connecting the first heat sink with the second heat sink, a plurality of LED modules mounted on the first heat sink and an envelope located between the lamp seat and the second heat sink and surrounding the first heat sink. The first heat sink includes an annular base and a plurality of first fins and second fins extending therefrom. The LED modules are mounted on the first fins, respectively, and around the annular base. Each heat pipe has two parallel sections respectively attached to a corresponding first fin and an inner circumferential periphery of the annular base, and a connecting section interconnecting the two parallel sections and sandwiched between the first heat sink and the second heat sink. Heat generated by the LED modules is transferred from the first heat sink to the second heat sink via the heat pipes, enhancing heat dissipation of the LED lamp. Moreover, since the LED modules are mounted around the first heat sink, light generated by the LED modules radiates in multiple directions, increasing illumination area of the LED lamp.

Other advantages and novel features will become more apparent from the following detailed description of preferred embodiments when taken in conjunction with the accompanying drawings.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric, assembled view of an LED lamp in accordance with an embodiment of the disclosure.

FIG. 2 is an assembled view of FIG. 1 with an envelope of the LED lamp removed for clarity.

FIG. 3 is an exploded view of the LED lamp of FIG. 1.

FIG. 4 is an inverted view of the LED lamp of FIG. 3.

FIG. 5 is a top view of a first heat sink of the LED lamp of FIG. 3.

### DETAILED DESCRIPTION OF THE INVENTION

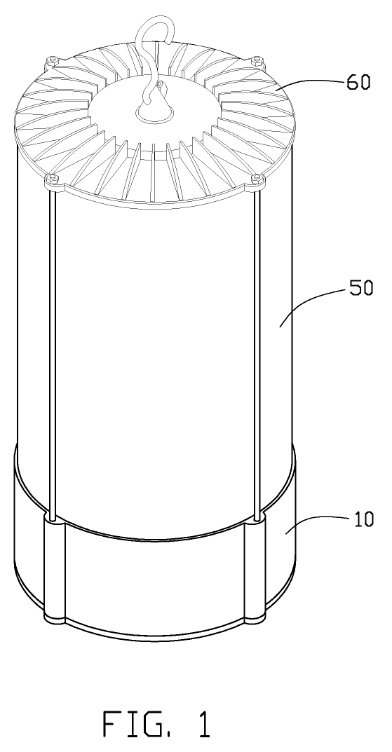

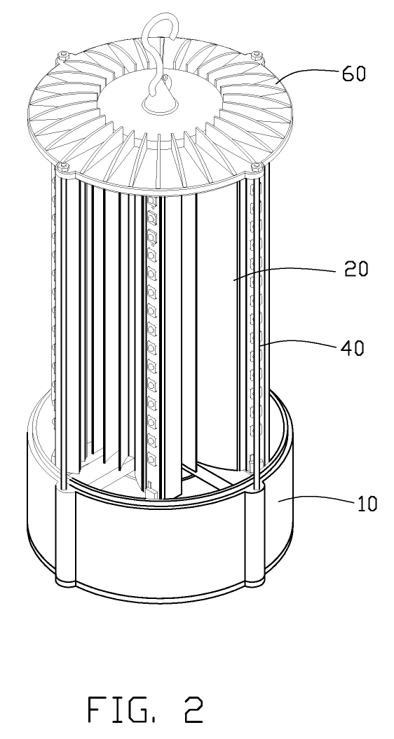

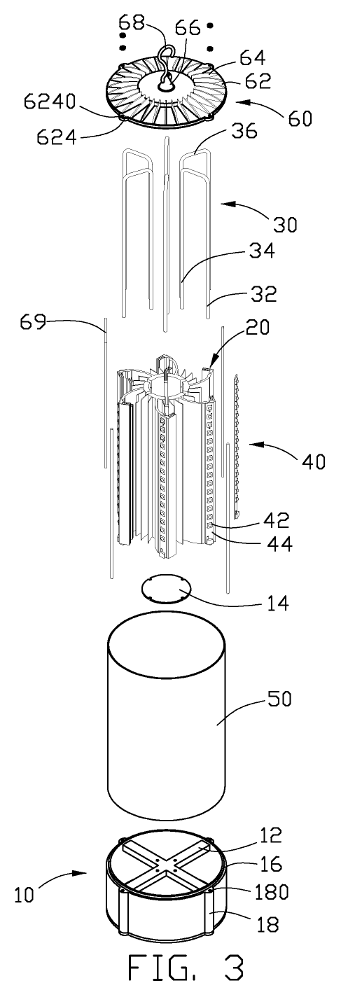

Referring to FIGS. 1-3, an LED lamp in accordance with an embodiment of the disclosure comprises a lamp seat 10, a prism-shaped first heat sink 20 disposed on a top of the lamp seat 10, a second heat sink 60 covering a top of the first heat sink 20, a plurality of heat pipes 30 thermally connecting the first heat sink 20 with the second heat sink 60, a plurality of LED modules 40 mounted on a periphery of the first heat sink 20, and an envelope 50 located between the lamp seat 10 and the second heat sink 60 and surrounding the first heat sink 20.

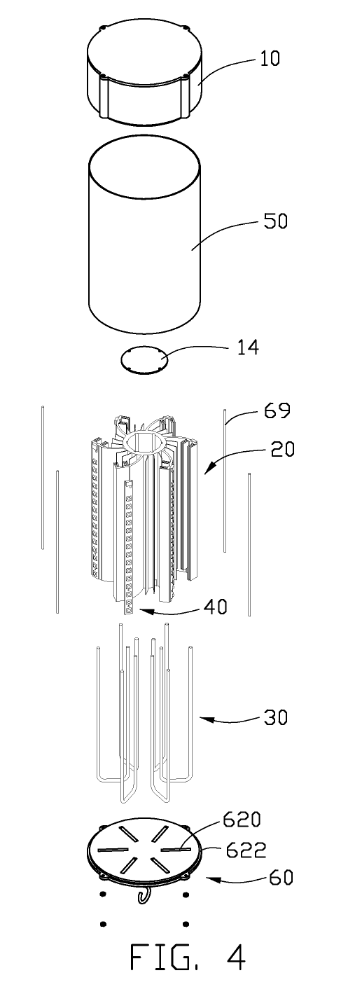

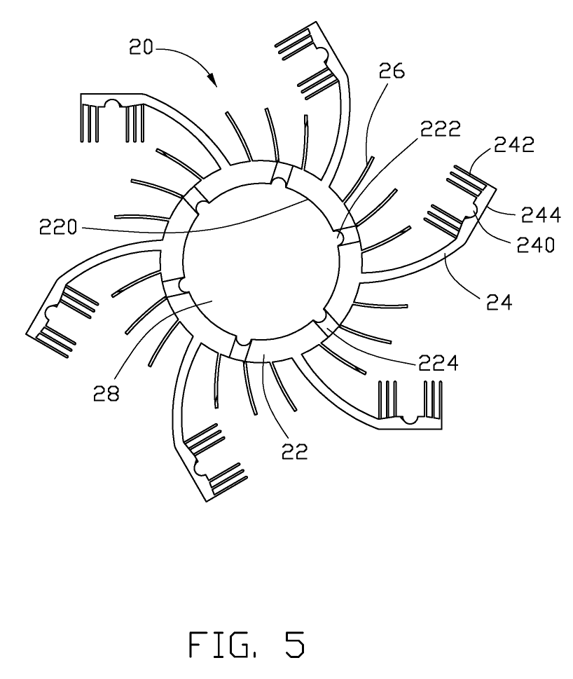

Also referring to FIGS. 4-5, the lamp seat 10 is integrally formed and has a substantially hollow, cylindrical configuration. A cross-shaped support 12 is mounted in the lamp seat 10 and defines four threaded holes (not labeled) receiving four screws (not shown) therein which extend through a driving circuit 14, fastening the driving circuit 14 to a top surface of the cross-shaped support 12. The lamp seat 10 forms an annular step 16 at a top of an outer circumferential periphery thereof, engaging a bottom of the envelope 50. Four straight parallel protrusions 18, each having a semi-circular cross section, uniformly extend from the outer circumferential periphery of the lamp seat 10 along a height thereof. Each of the protrusions 18 defines a through hole 180.

The first heat sink 20 and the second heat sink 60 are made of metal such as aluminum, copper or an alloy thereof. The first heat sink 20 comprises a hollow annular base 22, a plurality of curved first fins 24 and a plurality of curved second fins 26 extending outwardly from a cylindrical outer face of the annular base 22. A circular through hole 28 is defined from a bottom to a top along an axis of the annular base 22 and located in a centre of the first heat sink 20, thereby defining a cylindrical inner face 220 of the annular base 22. Six straight and parallel grooves 222 each having a semi-circular cross section are evenly defined at the inner face 220 along the axis of the annular base 22 and around the through hole 28 of the first heat sink 20. The six grooves 222 communicate with the through hole 28 of the first heat sink 20. Each groove 222 is located near a midmost second fin 26 located between two adjacent first fins 24. The top of the annular base 22 evenly defines six cutouts 224 communicating with the six grooves 222, respectively. The first fins 24 and the second fins 26 are all curved in a counterclockwise orientation when viewed from a top thereof. Opposite first fins 24 and second fins 26 are symmetric with respect to the axis of the annular base 22. The first fins 24 and the second fins 26 are evenly spaced. The first fins 24 are wider and longer than the second fins 26. The first fins 24 each form a planar mounting plate 244 at a distal end thereof. The mounting plate 244 is further bent counterclockwise toward the base 22. The mounting plate 224 has an outer side surface receiving a corresponding LED module 40 thereon, and an opposite inner side surface which defines a straight slot 240 at a middle thereof, accommodating a corresponding part of the heat pipe 30. A plurality of parallel third fins 242 extend perpendicularly from the inner side surface of each mounting plate 244 and are evenly distributed at two sides of the slot 240.

The heat pipes 30 interconnect the first heat sink 20 and the second heat sink 60. Each of the heat pipes 30 has a U-shaped configuration with two parallel sections thereof respectively functioning as an evaporating section 32 and a condensing section 34. A connecting section interconnecting the two parallel sections, is employed as an adiabatic section 36. Each of the evaporating sections 32 of the heat pipes 30 is accommodated in a corresponding slot 240 of the first fins 24, each of the adiabatic sections 36 of the heat pipes 30 is received in a corresponding cutout 224 of the first heat sink 20 and a bottom of the second heat sink 60, and each of the condensing sections 34 of the heat pipes 30 is accommodated in a corresponding groove 222 of the annular base 22.

The LED modules 40 each comprise a rectangular printed circuit board (hereinafter PCB) 44 and a plurality of spaced LEDs 42 mounted on the PCB 44. Each LED module 40 is fixed on the outer side surface of the mounting plate 244.

The envelope 50 is cylindrical and is made of transparent or semitransparent material such as glass.

The second heat sink 60 is located on the top of the first heat sink 20. The second heat sink 60 includes a circular base 62 and a plurality of fins 64 extending upwardly and perpendicularly from a top surface of the base 62. Four flanges 624 corresponding to the four protrusions 18 of the lamp seat 10 extend outwardly from a circumferential periphery of the base 62. Each flange 624 defines a through hole 6240. A conical fastening portion 66 with a hook 68 fixed thereon is formed at a centre of the top surface of the base 62. The hook 68 is used for hanging the LED lamp on a desired position. Six channels 620 (see FIG. 4) are defined in a bottom surface of the base 62, receiving the adiabatic sections 36 of the heat pipes 30. The base 62 reduces in circumference at a bottom of a circumferential periphery thereof and forms an annular step 622 engaging a top of the envelope 50. The fins 64 surround the fastening portion 66 and are evenly distributed at the top surface of the base 62. Each fin 64 decreases in height from an inner surface to an outer surface of the base 62.

In assembly of the LED lamp, the first heat sink 20 with the LED modules 40 attached to the outer side surfaces of the mounting plates 244 thereof, is disposed on the top of the lamp seat 10. The envelope 50 is mounted on the lamp seat 10 and surrounds the LED modules 40 and the first heat sink 20, with the bottom thereof sleeved on the annular step 16 of the lamp seat 10. The heat pipes 30 connect the first heat sink 20 with the second heat sink 60, with the evaporating sections 32, the adiabatic sections 36 and the condensing sections 34 respectively accommodated in the slots 240 of the first heat sink 20, the channels 620 of the second heat sink 60 and the cutouts 224 of the first heat sink 20, and the grooves 222 of the first heat sink 20. The top of the envelope 50 encloses the annular step 622 of the second heat sink 60. Finally, four bolts 69 extend through the through holes 6240 of the four flanges 624 of the second heat sink 60 and the through holes 180 of the four protrusions 18 of the lamp seat 10 in sequence, assembling all elements of the LED lamp together.

In use, when the LEDs 42 are activated, a part of the heat generated from the LEDs 42 is directly conducted to the first fins 24 and the third fins 242 of the first heat sink 20, and dissipated to ambient space via the first fins 24 and the third fins 242. Since the heat pipes 30 connect the first heat sink 20 with the second heat sink 60, the heat in the first heat sink 20 can also be transferred to the second heat sink 60, and dissipated to the ambient space by the fins 64 of the second heat sink. Remaining heat is transmitted to the base 22 of the first heat sink 20 via the heat pipes 30 and the first fins 24, finally exhausted to the ambient space via the second fins 26. The LED lamp has enhanced heat dissipating capability, preventing the LEDs 42 from overheating. Moreover, since the LED modules 40 are mounted around the periphery of the first heat sink 20, light generated by the LED modules 40 is emitted in multiple directions, increasing illumination area of the LED lamp.

It is believed that the disclosure and its advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An LED lamp, comprising:
a prism-shaped first heat sink comprising a hollow annular base and a plurality of first fins extending outwardly therefrom; and
a plurality of LED modules mounted on the plurality of first fins and around the annular base of the first heat sink, each LED module comprising a printed circuit board and a plurality of LEDs mounted thereon.

2. The LED lamp as claimed in claim 1, wherein the plurality of first fins is curved from the annular base of the first heat sink along a same direction, the plurality of LED modules being mounted on free ends of the plurality of first fins, respectively.

3. The LED lamp as claimed in claim 2, wherein a plurality of second fins extend outwardly and curve from the outer face of the annular base and are located between the plurality of first fins.

4. The LED lamp as claimed in claim 3, wherein the plurality of first fins and the plurality of second fins are evenly spaced, each of the plurality of first fins being larger than each of the plurality of second fins.

5. The LED lamp as claimed in claim 4, wherein each of the plurality of first fins forms a mounting plate at a distal end thereof, the mounting plate having an outer side surface on which a corresponding LED module is attached, and an opposite inner side surface forming a plurality of third fins.

6. The LED lamp as claimed in claim 5, wherein the mounting plate is further bent toward the annular base, and the plurality of third fins is perpendicular to the mounting plate.

7. The LED lamp as claimed in claim 5, further comprising a plurality of heat pipes, wherein each of the plurality of heat pipes comprises an evaporating section accommodated in the inner side surface of the mounting plate, a condensing section accommodated in an inner face of the annular base and an adiabatic section interconnecting the evaporating section and the condensing section.

8. The LED lamp as claimed in claim 7, further comprising a second heat sink, wherein the second heat sink is disposed on a top of the first heat sink, and the adiabatic sections of the heat pipes are sandwiched between the first heat sink and the second heat sink.

9. The LED lamp as claimed in claim 8, further comprising a lamp seat, on which the first heat sink is mounted.

10. The LED lamp as claimed in claim 9, further comprising an envelope, surrounding the first heat sink and the plurality of LED modules, wherein a top and bottom of the envelope engage with a bottom of the second heat sink and a top of the lamp seat, respectively.

11. The LED lamp as claimed in claim 8, wherein the second heat sink comprises a circular base and a plurality of fins extending upwardly from a top surface of the base, a fastening portion with a hook fixed thereon being formed at a centre of the top surface of the base, and the plurality of fins on the base surrounding the fastening portion and each having a height decreasing from an inner surface toward an outer surface of the base.

12. A heat sink assembly for dissipating heat from LED modules, comprising:
a prism-shaped first heat sink comprising a hollow annular base and a plurality of first fins extending outwardly from an outer face of the annular base, a heat pipe comprising a first section, a second section parallel to the first section and a third section interconnecting the first section and the second section, wherein the first section of the heat pipe is connected to a corresponding first fin, and the second section is connected to an inner face of the annular base.

13. The heat sink assembly as claimed in claim 12, wherein a plurality of third fins extends from the each of the plurality of first fins, and wherein the first section of the heat pipe is between the plurality of third fins.

14. The heat sink assembly as claimed in claim 13, wherein a plurality of second fins extend outwardly from the outer face of the annular base and are located between the first fins, and the second section of the heat pipe is located near a middle one of the second fins.

15. The heat sink assembly as claimed in claim 14, wherein each first fin has a first surface from which the plurality of third fins perpendicularly extend, and a flat second surface adapted for mounting a corresponding LED module thereon.

16. The heat sink assembly as claimed in claim 15, further comprising a second heat sink disposed on a top of the first heat sink, the third section of the heat pipe being sandwiched between the first heat sink and the second heat sink.

17. The heat sink assembly as claimed in claim 15, wherein the plurality of first fins and the plurality of second fins are curved in a counterclockwise orientation when viewed from a top of the first heat sink, and the plurality of third fins is extended towards the annular base.

18. An LED lamp, comprising:
a prism-shaped first heat sink comprising a hollow annular base defining a plurality of grooves communicating with a central hole of the annular base and a plurality of first fins extending outwardly and curvedly therefrom, each first fin having a mounting plate at a distal end thereof, the mounting plate having opposite first and second face, the first face defining a slot therein, a plurality of fins extending from the first face and beside the slot;
a plurality of LED modules each mounted on the second face of the mounting plate of a corresponding first fin and around the annular base of the first heat sink, each LED module comprising a printed circuit board and a plurality of LEDs mounted thereon; and
a plurality of heat pipes each having an evaporating section received in the slot and thermally connecting with the mounting plate and a condensing section received in a corresponding groove and thermally connecting with the annular base.

19. The LED lamp as claimed in claim 18, wherein the annular base further comprises a plurality of second fins between the first fins.

20. The LED lamp as claimed in claim 18, further comprising a disc-shaped second heat sink mounted on a top of the first heat sink and thermally connecting with the heat pipes.
